(19) United States
(12) Patent Application Publication
(10) Pub. No.: US 2024/0416302 A1
(43) Pub. Date: Dec. 19, 2024

(54) Mixing machine for continuously mixing powder material into a liquid flow

(71) Applicant: DROMONT S.p.A., Grinzane Cavour Cuneo (IT)

(72) Inventor: Luca DROCCO, Alba Cuneo (IT)

(21) Appl. No.: 18/746,254

(22) Filed: Jun. 18, 2024

(30) Foreign Application Priority Data
Jun. 19, 2023 (IT) 102023000012591

(51) Int. Cl. B01F 29/25; B01F 23/50; B01F 29/00; B01F 35/30; B01F 35/32

(52) U.S. Cl. CPC B01F 29/252; B01F 23/56; B01F 29/4032; B01F 35/3204; B01F 35/3211; B01F 2035/351

(57) ABSTRACT

A mixing machine for continuously mixing powder material in a liquid flow, including a mixing body including: a mixing section in which a rotor is rotatably mounted, a liquid inlet section located above the mixing section, and a powder inlet section located above the liquid inlet section The powder inlet section is movable between a closed position and an open position, such that in the closed position the powder inlet section closes an upper edge of the liquid inlet section, and in the open position the powder inlet section is detached from the upper edge of the liquid inlet section.

### FIELD OF THE INVENTION

The present invention relates to mixing machines.

More specifically, the invention relates to a mixing machine for continuously mixing a powder material into a liquid flow.

The invention was developed in particular with a view to its application to the paint preparation field, but it is understood that it is not limited to this specific field.

### DESCRIPTION OF THE PRIOR ART

In the field of paint production, mixtures of powders and liquids are often used, for example, for producing paint bases, dyes, thickening mixtures, etc. These liquid products are obtained by mixing pre-established percentages of powder material with various types of liquids such as water, resins, solvents, oils, etc.

Powder and liquid mixers can be batch mixers that work in separate batches. The powders and liquids are introduced into a mixing chamber and are mixed until the required consistency is achieved. Once mixing is complete, the mixture can be discharged and sent to the next process.

The use of batch mixers often generates drawbacks, particularly in the production of thickeners, as the mixture sometimes becomes unexpectedly very viscous, and it is no longer possible to extract it from the mixing container.

To overcome these problems, mixers that operate continuously have been proposed, allowing a constant flow of mixed products. Powders and liquids are continuously fed into a mixing chamber and mixed as they pass through the mixer. Continuous mixers are equipped with high-speed stirring rotors that rotate inside a mixing chamber and allow fast and efficient mixing. These mixers are suitable for large-scale mix production and are often used to mix powders and liquids that require intensive dispersion to achieve uniform distribution of the handled materials.

In continuous mixers, the mixing chamber is completely enclosed in the mixing body. Therefore, when it is necessary to carry out maintenance operations, such as replacing the rotor or cleaning the mixing chamber, it is necessary to dismantle a part of the mixing body, which involves a high time-commitment of maintenance personnel and long plant downtimes.

### OBJECT AND SUMMARY OF THE INVENTION

The object of the present invention is to provide a mixing machine that overcomes the problems of the prior art

According to the present invention, this object is achieved by a mixing machine having the characteristics forming the subject of claim 1.

The claims form an integral part of the disclosure provided here in relation to the invention.

### BRIEF DESCRIPTION OF THE DRAWINGS

The present invention will now be described in detail with reference to the attached drawings, given purely by way of non-limiting example, in which:

FIG. 1 is a perspective view of a continuous-flow mixing machine according to the present invention,

FIGS. 2 and 3 are axial sections of the mixing machine of FIG. 1 in the working position and in a stop position, respectively,

FIG. 4 is an axial section of the mixing machine of FIG. 1 in an open configuration,

FIG. 5 is a view on an enlarged scale of the part indicated by the arrow V in FIG. 4, and

FIG. 6 is a perspective view of the opening device indicated by the arrow VI in FIG. 4.

### DETAILED DESCRIPTION

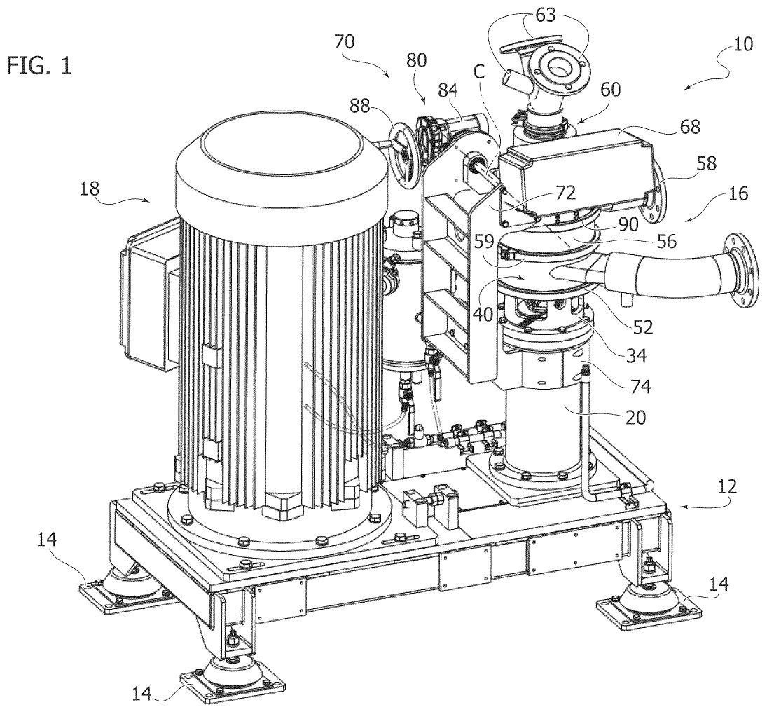

With reference to FIGS. 1-4, numeral 10 indicates a mixing machine for continuously mixing powder material into a liquid flow.

The mixing machine 10 comprises a support base 12 which can be provided with feet 14 that rest on the ground.

The support base 12 carries a mixing body 16 and an electric motor 18.

The mixing body 16 comprises a tubular support section 20 extending upwards from the support base 12 and having a lower end attached to the support base 12.

A drive shaft 22 is rotatably mounted inside the tubular support section 20 of the mixing body 16 about a vertical axis A. The drive shaft 22 is supported by the tubular support section 20 by bearings 24. The drive shaft 22 has a lower end connected to the electric motor 18 via a transmission 26. The transmission 26 may comprise a belt 28 cooperating with two pulleys 30, 32, one of which includes a clutch, fixed respectively to the outlet shaft of the electric motor 18 and to the lower end of the drive shaft 22.

The mixing body 16 comprises a sealing section 34 located at the upper end of the tubular support section 20. Housed inside the sealing section 34 is a seal 36, for example, a mechanical seal, through which an upper section 38 of the drive shaft 22 extends. The sealing section 34 may be fixed by screws to the upper end of the tubular support section 20.

The mixing body 16 comprises a mixing section 40 located above the sealing section 34. In the mixing section 40 a mixing chamber 42 is formed in which a rotor 44 rotatable about the vertical axis A is rotatably mounted. The rotor 44 is attached to the upper end of the drive shaft 22 which protrudes into the mixing chamber 42 above the seal 36. The seal 36 isolates the mixing chamber 42 from the drive shaft 22 by a mechanical seal with a liquid barrier. Inside the mixing chamber 42 a stator 46 may be housed which surrounds the rotor 44. The mixing section 40 comprises an outlet duct 50 communicating with the mixing chamber 42.

The mixing section 40 may be attached to the upper end of the sealing section 34 by a first clamp 52. An O-ring can be arranged between the mutual contact surfaces of the mixing section 40 and the sealing section 34.

The mixing body 16 comprises a liquid inlet section 56 located above the mixing section 40. The liquid inlet section 56 forms a liquid inlet chamber 57 located above the mixing chamber 42. The liquid inlet section 56 comprises a liquid inlet duct 58 through which a flow of liquid is fed to the mixing chamber 42.

The liquid inlet section 56 may be attached to the upper end of the mixing section 40 by a second clamp 59. An O-ring can be arranged between the mutual contact surfaces of the liquid inlet section 56 and the mixing section 40.

The mixing body 16 comprises a powder inlet section 60 located above the liquid inlet section 56. A through-channel 62 extends through the powder inlet section 60. The through-channel 62 has a lower end that communicates with the liquid inlet chamber 57, and an upper end that communicates with at least one powder inlet duct 63 through which a flow of powder material is fed to the mixing chamber 42. In the example illustrated in the figures, the powder inlet section 60 comprises a plurality of powder inlet ducts 63, which may be used simultaneously to feed different types of powder material or alternately to ensure continuity of the feeding of the powder material when the containers of powder materials run out.

The powder inlet section 60 comprises a valve 64 having a valve member 66 cooperating with a valve seat formed in the through-channel 62 of the powder inlet section 60.

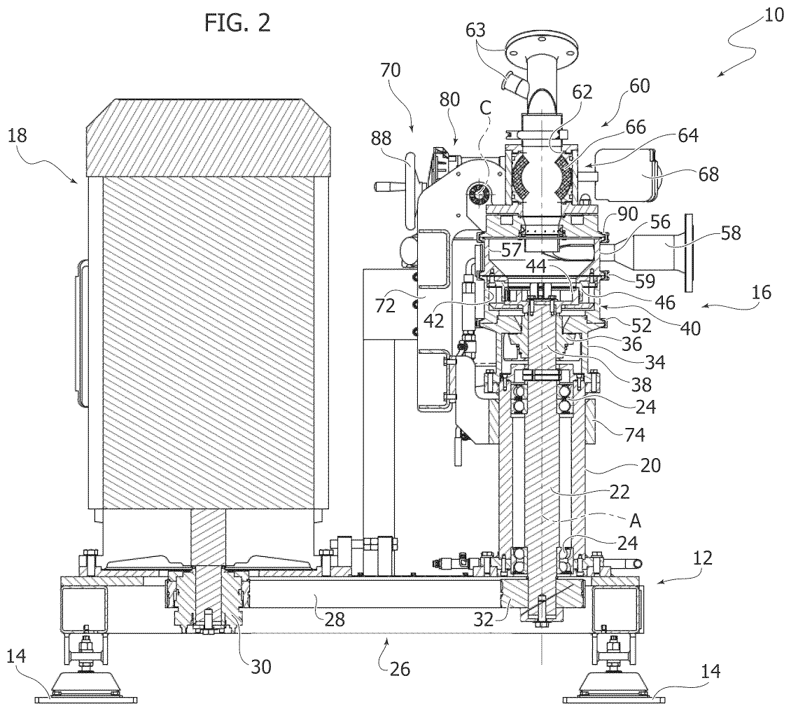

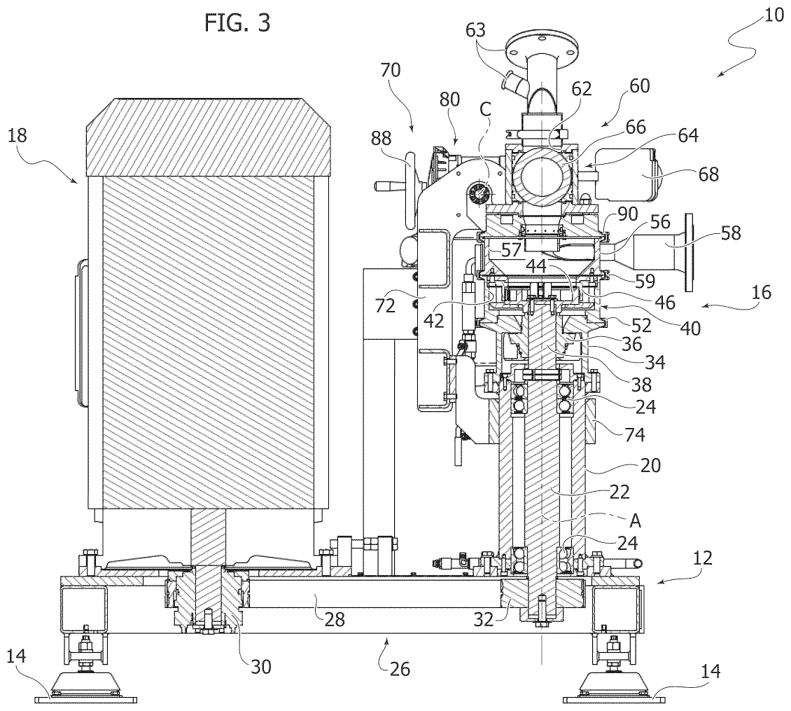

The valve member 66 is movable between an open position (FIG. 2) and a closed position (FIG. 3). In the open position of the valve 66 the through-channel 62 is open and the or each powder inlet duct 63 is in communication with the liquid inlet chamber 57. In the closed position of the valve 64 the through-channel 62 is closed and isolates the or each powder inlet duct 63 from the liquid inlet chamber 57.

The valve 64 may be a ball valve. In this case, the valve member 66 is a spherical body rotatable around an axis orthogonal to the vertical axis A. In particular, the valve 64 may be a bottom ball valve so as to reduce the distance between the valve seat and the liquid inlet chamber 57. The valve member 66 may be controlled by an actuator 68 carried by the powder inlet section 60.

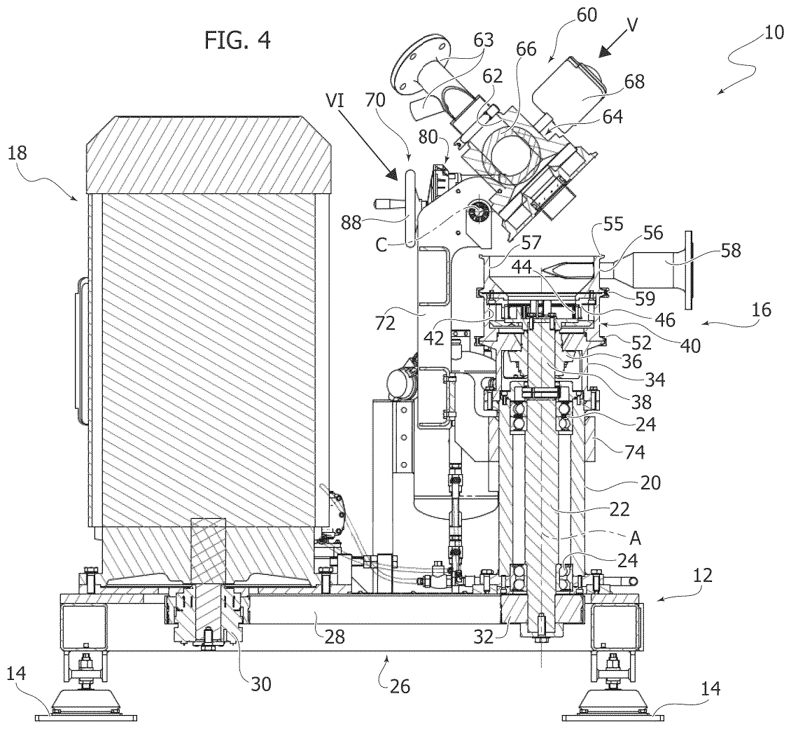

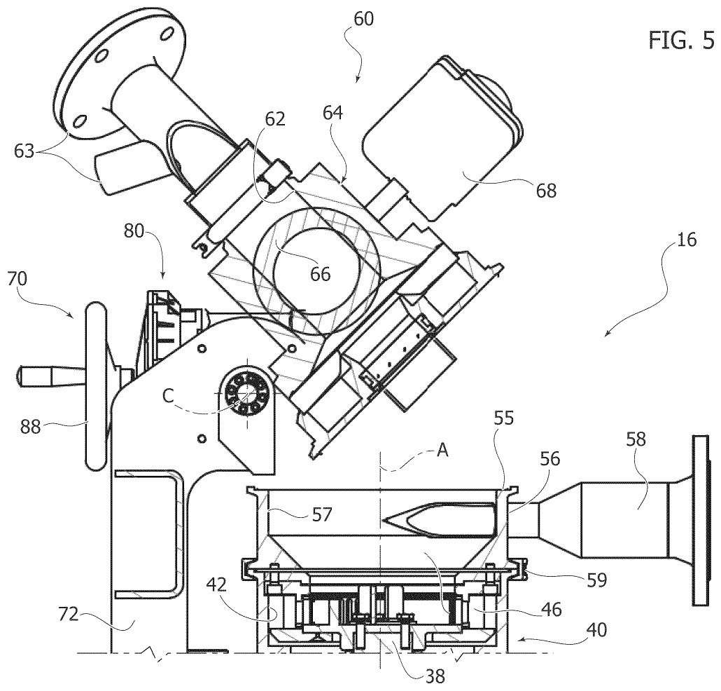

The powder inlet section 60 is movable between a closed position (FIGS. 2 and 3) and an open position (FIGS. 4 and 5).

In the closed position, the powder inlet section 60 closes an upper edge 55 of the liquid inlet section 57. In the open position, the powder inlet section 60 is detached from the upper edge 55 of the liquid inlet section 57.

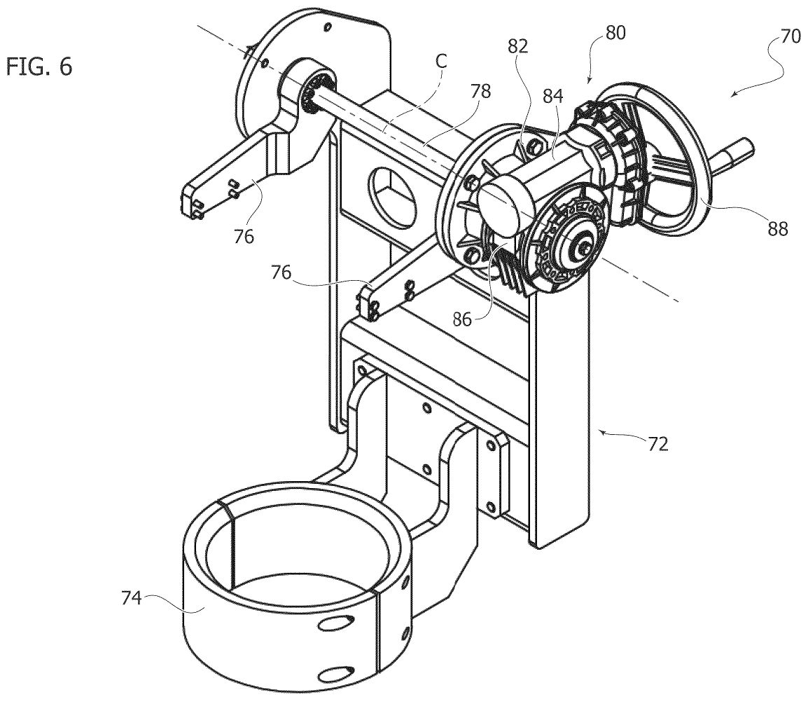

The powder inlet section 60 is carried by an opening device 70 illustrated in greater detail in FIG. 6. The opening device 70 comprises a stationary frame 72 which may be fixed to the tubular support section 20 of the mixing body 16 by a flange 74. The opening device 70 has two arms 76 attached to a shaft 78 rotatable with respect to the stationary frame 72 around a horizontal axis C. The rotation of the arms 76 around the axis C is controlled by a control device 80 which may include a transmission 82 having a worm 84 and a worm wheel 86. The control device may be operated by a manually operated crank 88 or by an electric motor. In the closed position, the powder inlet section 60 may be attached to the liquid inlet section 57 by a third clamp 90.

An O-ring may be arranged between the mutual contact surfaces of the powder inlet section 60 and the liquid inlet section 56.

During normal operation, the mixing machine 10 is in the configuration illustrated in FIG. 2, in which the valve 64 is in the closed position when the machine starts, and open after starting to allow mixing of the liquid with the powders. A flow of liquid is fed at a controlled rate to the liquid inlet chamber 57 via the liquid inlet duct 58, and subsequently a metered flow of powder material is fed to the liquid inlet chamber 57 via at least one powder inlet duct 62.

The liquid flow and the powder material flow enter the mixing chamber 42. The rotor 44 rotates the flow of liquid and powder material between the blades of the stator 46 and produces a homogeneous mixture between the liquid and the powder material.

The rotor 44 functions as the rotor of a centrifugal pump which sucks the liquid and powder material from the liquid inlet chamber 57 and sends the mixed product towards the outlet duct 50.

In the event of anomalies that cause the rotor 44 to stop or slow down, the valve 64 is closed. In this way, the liquid contained in the liquid inlet chamber 57 is prevented from rising towards the powder inlet duct 62.

Closing the valve 64 therefore prevents blockages and clogs from forming in the powder inlet duct 62. In the event of anomalies, the valve 64 may be closed automatically via the actuator 68. The valve 64 may be normally closed, so that in the absence of a positive command from the actuator 68, the valve 64 is closed. In possible embodiments, the movement of the valve member 66 towards the closed position may be controlled manually.

To carry out maintenance operations, such as replacing the rotor 44 or cleaning the mixing chamber 42, the powder inlet section 60 is lifted by rotating it around the axis C using the opening device 70.

Once the powder inlet section 60 has been raised, the liquid inlet section 56 can be removed. In this way there is free access to the mixing chamber 42 and the rotor 44 can be replaced.

Of course, without prejudice to the principle of the invention, the details of construction and the embodiments can be widely varied with respect to those described and illustrated, without thereby departing from the scope of the invention as defined by the claims that follow.

1. A mixing machine for continuously mixing powder material into a liquid flow, including a mixing body comprising:
a mixing section having a mixing chamber in which a rotor is rotatably mounted, wherein the mixing section has an outlet duct communicating with the mixing chamber,
a liquid inlet section located above the mixing section and forming a liquid inlet chamber, wherein the liquid inlet section includes a liquid inlet duct communicating with the liquid inlet chamber,
a powder inlet section located above the liquid inlet section and having a through-channel having a lower end communicating with the liquid inlet chamber and an upper end that communicates with at least one powder inlet duct,
wherein the powder inlet section is movable between a closed position and an open position, wherein in the closed position the powder inlet section closes an upper edge of the liquid inlet section and in the open position the powder inlet section is detached from the upper edge of the liquid inlet section.

2. The mixing machine of claim 1, comprising an opening device including a stationary frame carrying two arms fixed to the powder inlet section and fixed to a shaft rotatable relative to the stationary frame about a horizontal axis.

3. The mixing machine of claim 2, wherein the opening device comprises a control device including a transmission having a worm and a worm wheel.

4. The mixing machine of claim 3, wherein the control device is controlled by a manually operable crank or by an electric motor.

5. The mixing machine of claim 2, wherein the mixing body comprises a tubular support section and wherein the stationary frame of the opening device is fixed to the tubular support section of the mixing body by a flange.

6. The mixing machine of claim 1, comprising a support base which carries said mixing body and an electric motor,
wherein the mixing body comprises a tubular support section having a lower end fixed to the support base and extending upwards from the support base,
wherein a drive shaft is rotatably mounted within the tubular support section about a vertical axis, and
wherein the drive shaft is supported by the tubular support section by bearings and has a lower end connected to said electric motor by a transmission.

7. The mixing machine of claim 6, wherein the mixing body comprises a sealing section located at the upper end of the tubular support section, in which a seal is housed, through which an upper section of said drive shaft extends.

8. The mixing machine of claim 7, wherein the mixing section is fixed to the upper end of the tubular support section by a first clamp, wherein the liquid inlet section is fixed to an upper end of the mixing section by a second clamp, and wherein in the closed position the powder inlet section is fixed to the liquid inlet section by a third clamp.

9. The mixing machine of claim 7, wherein respective O-rings are arranged between mutual contact surfaces of the sealing section, mixing section, liquid inlet section, and powder inlet section.

10. The mixing machine of claim 1, wherein the powder inlet section comprises a valve having a valve member rotatable in a valve seat formed in the through-channel of the powder inlet section.
